(19) United States
(12) Patent Application Publication
(10) Pub. No.: US 2005/0058909 A1
(43) Pub. Date: Mar. 17, 2005

(54) Use of grass lignins in thermoplastics

(75) Inventor: Jaime Navarrete, Owensboro, KY (US)

Correspondence Address: ROBERT H. HAMMER III, P.C., 3121 SPRINGBANK LANE, SUITE I, CHARLOTTE, NC, 28226, US

(73) Assignee: Daramic, Inc.

(21) Appl. No.: 10/664,147

(22) Filed: Sep. 17, 2003

(51) Int. Cl. H01M 2/16; C08L 97/00; C08L 99/00

(52) U.S. Cl. 429/254; 429/255; 429/252; 524/76

(57) ABSTRACT

The instant invention is directed to the use of grass lignin in thermoplastics (such as: ultra-high molecular weight polyethylene (UHMWPE)). In this invention, grass lignins are added to a lead acid battery separator comprising a microporous membrane including an ultra-high molecular weight polyethylene, a filler, and a processing oil.

### FIELD OF THE INVENTION

This invention is directed to the use of grass lignins in thermoplastics (such as: ultra-high molecular weight polyethylene (UHMWPE)).

### BACKGROUND OF THE INVENTION

Lignin is a by-product of wood pulping or non-wood pulping operations. Lignin's chemical structure is extremely complex. Lignin is generally accepted to be a three dimensional, crosslinked polymer comprised of three different phenyl propenol moieties. The relative amounts of the three monomeric compounds, coumaryl alcohol, coniferyl alcohol, and sinapyl alcohol, vary with the sources of the lignin. Lignins vary in structure according to their method of isolation and their plant sources. Jario H. Lora and W. G. Glasser, “Recent Industrial Application of Lignins: A Sustainable Alternative to Nonrenewable Materials,” Journal of Polymers and Environment, p. 39, (2002). Non-wood sources of lignin include, but are not limited to, bagasse, straw, abaca, sisal, flax, jute, and hemp. Jario H. Lora, “Characteristics, Industrial Sources, Utilization of Lignins from Non-Wood Plants,” Chemical Modifications, Properties, and Usage of Lignin, p. 267, (Plenum Publisher, 2002). Softwood lignins, such as obtained from spruce, pine, redwood, cedar. Hardwood lignins are obtained, or substantially obtained, from oak, cherry, maple, birch, sweet gum, mahogany, and the like.

A thermoplastic refers to a polymer that softens or melts when exposed to heat and returns to its original condition when cooled. Ultra-high molecular weight polyethylene (UHMWPE) refers to a polymer with molecular weight greater than 1 million and preferably in the range of about 5 million to about 7 million. UHMWPE has many unique properties, but it is extremely difficult to process, i.e., form into usable shapes. Conventional extrusion and molding techniques cannot be used. When extrusion techniques are used, the energy added to the polymer by the extruder may cause chain scissions (e.g., thermal degradation), which, in turn, detrimentally affects the polymer. Rubin, I. I., Editor, Handbook of Plastic Materials and Technology, John Wiley & Sons, Inc., NYC, NY, (1990), p. 349-354, Stein, H. L., “Ultra High Molecular Weight Polyethylene (UHMWPE)”, Engineered Materials Handbook, Vol. 2 Engineering Plastics, ASM International, Metals Park, Ohio, 1988, and U.S. Pat. No. 4,778,601, each is incorporated herein by reference. Accordingly, UHMWPE is often mixed with oils or oils and fillers to facilitate extrusion.

U.S. Pat. No. 6,485,867, herein incorporated by reference, discloses the use of wood lignins in thermoplastics.

Poisoning of lead acid storage batteries is known. One poison is antimony (Sb), which is an alloying component of the lead used in the batteries. Antimony poisoning causes a reduction in hydrogen overvoltage. Several solutions to the antimony-poisoning problem have been suggested. For example, see: U.S. Pat. No. 5,221,587—an uncrosslinked natural or synthetic rubber is a layer on or incorporated into microporous or glass fiber separators (also see column 2, line 51—column 3, line 14 for a discussion of additional solutions); U.S. Pat. No. 5,759,716—organic polymers having an affinity for the metal impurity (e.g., Sb) are incorporated into, for example, the separator; European Published Application No. EP 0 910 130 A1-thiolignins are incorporated into fibrous separators; and Japanese Published Application (Kokai) No. 11-191405—lignins are impregnated or coated on a glass mat separator.

There is still an on-going need to find ways to reduce poisoning in lead acid storage batteries in an economical and efficient manner.

### SUMMARY OF THE INVENTION

The instant invention is directed to the use of grass lignins in thermoplastics (such as: ultra-high molecular weight polyethylene (UHMWPE)). In this invention, grass lignins are added to a lead acid battery separator comprising a microporous membrane including an ultra-high molecular weight polyethylene, a filler, and a processing oil.

### DETAILED DESCRIPTION OF THE INVENTION

In this invention, a grass lignin is added to a microporous battery separator for a lead acid battery made from ultra-high molecular weight polyethylene. The grass lignin acts as an antimony suppressor, which reduces antimony poisoning within the battery. When grass lignins are used, there is a less noticeable discoloration of the separator as in comparison to when wood lignins are used in battery separators. Furthermore, when grass lignins are used, the odor is dramatically reduced as in comparison to when wood lignins are used in battery separators. Battery separators made with ultra-high molecular weight polyethylene are known. See for example U.S. Pat. No. 3,351,495; and Besenhard, J. O., Editor, Handbook of Battery Materials, Wiley-VCH, NYC, NY (1999) p. 258-263, both are incorporated herein by reference.

The lead acid battery separator generally comprises a microporous membrane made from UHMWPE, fillers, processing oil and lignin. The microporous membrane has an average pore size in the range of about 0.1 to about 1.0 micron, a porosity greater than 10% (preferably between about 55% and about 85%; and most preferably between about 55% and about 70%), and the pore structure is referred to as an open cell structure or interconnected pore structure. The membrane generally comprises about 15-25% by weight UHMWPE, 50-80% by weight filler, 0-25% by weight process oil, and 5-20% grass lignin. Additionally, minor amounts of processing aids may be added. Preferably, the membrane comprises 17-23% by weight UHMWPE, 50-60% filler, 10-20% processing oil, and 5-10% grass lignin. These materials are mixed and extruded in a known fashion. See, for example: U.S. Pat. No. 3,351,495; and Besenhard, J. O., Editor, Handbook of Battery Materials, Wiley-VCH, NYC, NY (1999) p. 258-263, both are incorporated herein by reference.

UHMWPE refers to polyethylenes with a molecular weight greater than 1 million, preferably greater than 3 million. UHMWPE are commercially available from Ticona LLC, Bayport, Tex.

Filler refers to high surface area particles with an affinity for the processing oil. Preferred fillers include precipitated silica, oxide compounds, and mixtures thereof. Such silicas are commercially available from PPG, Pittsburgh, Pa. and Degussa-Huls AG, Frankfurt, Germany. Also see U.S. Pat. Nos. 3,351,495 and 4,861,644, incorporated herein by reference, for additional filler suggestions.

Processing oil (or plasticizer) refers to, for example, mineral oil, olefinic oil; parafinic oil, naphthenic oil, aromatic oil, and mixtures thereof. Processing oil performs two functions; first, it improves the processability of UHMWPE, and second, it is the extractable component, which is used to create the microporous structure of separator. Mineral oil is preferred and is commercially available from Equilon of Houston, Tex. Also see U.S. Pat. Nos. 3,351,495 and 4,861,644, incorporated herein by reference, for additional processing oil (or plasticizer) suggestions.

Grass lignin refers to those by-products of non-wood pulping operations having extremely complex chemical structures that consist of significant amounts of p-hydroxyphenyl propane derived from coumaryl alcohol precursor. Grass sources of lignin include, but are not limited to, bagasse, straw, abaca, sisal, flax, jute, and hemp. Grass sources from bagasse and flax are preferred. Grass lignins are commercially available from Granit SA, Lausanne, Switzerland.

Further explanation of this aspect of the invention will be set out in the examples below.

### EXAMPLES

The formulations set out in Table 1 were prepared.

TABLE 1

| Sam- | Polymer | | Oil | | |
|---|---|---|---|---|---|
| ple | (UHMWPE) | Filler | (Mineral Oil) | Lignin | Lignin type |
| 1 | 23% | 59% | 15% | 0% | None |
| 2 | 20% | 52% | 17.5% | 7.5% | Grass lignin B |
| 3 | 20% | 52% | 17.5% | 7.5% | Grass lignin F |
| 4 | 20% | 52% | 17.5% | 7.5% | Hardwood Lignin W |

The formulations of Table 1 set out in Table 2 were tested for Sb suppression. Results below were obtained via a cyclic voltammetry technique. Cyclic voltammetry techniques are known., Dietz, H., et al, “Influence of substituted benzaldehydes and their derivatives as inhibitors for hydrogen evolution in lead/acid batteries,” 53 Journal of Power Sources 359-365 (1995), incorporated herein by reference.

TABLE 2

| | Sb Peak Height | Current (mA) at Start |
|---|---|---|
| Sample | (mA) | of Sweep @ −1.200 V |
| Sample 1 + 15 ppm Sb | 2.81 | −2.92 |
| Sample 2 + 15 ppm Sb | 0.14 | −0.24 |
| Sample 3 + 15 ppm Sb | 0.93 | −0.24 |
| Sample 4 + 15 ppm Sb | 0.62 | −0.23 |

The formulations set out in Table 3 were prepared.

TABLE 3

| | Polymer | | Oil | | |
|---|---|---|---|---|---|
| Sample | (UHMWPE) | Filler | (Mineral Oil) | Lignin | Lignin type |
| 1 | 20% | 52% | 17.5% | 7.5% | Westvaco |
| | | | | | Hardwood Lignin |
| 2 | 20% | 52% | 17.5% | 7.5% | Grass lignin B |
| 3 | 20% | 52% | 17.5% | 7.5% | Grass lignin F |
| 4 | 20% | 52% | 17.5% | 7.5% | Westvaco |
| | | | | | Softwood Lignin |

The formulations of Table 3 set out in Table 4 were tested in a 6V golfcart battery for their end of charge current life cycles. Results below were obtained.

TABLE 4

| | | | | |
|---|---|---|---|---|
| Sample | 1 | 2 | 3 | 4 |

| | |
|---|---|
| Cycles | Current in Amps |

| | | | | |
|---|---|---|---|---|
| 2 | 5.0 | 5.3 | 4.6 | 6.8 |
| 24 | 2.5 | 2.0 | 1.7 | 3.1 |
| 49 | 2.3 | 2.3 | 1.6 | 3.1 |
| 74 | 2.3 | 2.2 | 1.8 | 3.1 |
| 99 | 2.5 | 2.8 | 1.9 | 3.7 |
| 124 | 3.2 | 3.0 | 2.1 | 4.1 |
| 149 | 3.9 | 3.8 | 2.4 | 4.8 |
| 174 | 4.5 | 3.9 | 3.3 | 6.2 |
| 199 | 5.1 | 4.2 | 3.0 | 6.9 |

The present invention may be embodied in other specific forms without departing from the spirit or essential attributes thereof and, accordingly, reference should be made to the appended claims, rather than the foregoing specification, indicating the scope of the invention.

1. A battery separator for lead acid batteries comprising:
a microporous membrane including
an ultra high molecular weight polyethylene,
a filler,
a processing oil, and
a grass lignin.

2. The separator of claim 1 wherein said grass lignin comprises about 5-20% by weight of said membrane.

3. The separator of claim 2 wherein said grass lignin comprises about 5-10% by weight of said membrane.

4. The separator of claim 1 wherein said grass lignin being sourced from bagasse, straw, abaca, sisal, flax, jute, hemp, and combinations thereof.

5. A lead acid battery including the separator of claim 1.

6. A battery separator for a lead acid battery comprises:
a microporous membrane having an open cell structure with pores sizes in the range of about 0.1 to about 1 micron and porosity greater than 10%, and further comprising:
about 15-25% by weight of said separator being an ultra high molecular weight polyethylene;
about 50-80% by weight of said separator being a filler;
less than about 25% by weight of the separator being a processing oil;
about 5-20% by weight of the separator being a grass lignin.

7. The separator of claim 6 wherein said filler being selected from the group consisting of precipitated silica, oxide compounds, and mixtures thereof.

8. The separator of claim 6 wherein said oil being selected from the group consisting of mineral oil, olefinic oil, parafinic oil, napthenic oil, aromatic oil, and mixtures thereof.

9. The separator of claim 6 wherein said grass lignin being sourced from bagasse, straw, abaca, sisal, flax, jute, hemp, and combinations thereof.

10. A thermoplastic polymer formulation comprising:
up to about 80% by weight of the formulation being thermoplastic polymer;
up to about 20% by weight of the formulation being a processing oil, and
up to about 10% by weight of the formulation being a grass lignin.

11. The formulation of claim 10 wherein said polymer being a polyolefin.

12. The formulation of claim 10 wherein said polymer being an ultrahigh molecular weight polyethylene.

13. The formulation of claim 10 wherein said polymer includes a filler.

14. The separator of claim 10 wherein said grass lignin being sourced from bagasse, straw, abaca, sisal, flax, jute, hemp, and combinations thereof.
